(19) United States
(12) Patent Application Publication
(10) Pub. No.: US 2026/0279205 A1
(43) Pub. Date: Sep. 17, 2026

(54) METHOD FOR ASSISTING IN THE LANDING OF AN AIRCRAFT

(71) Applicant: SAFRAN ELECTRONICS & DEFENSE, PARIS (FR)

(72) Inventors: Alain CHIODINI, MOISSY-CRAMAYEL (FR); Eric TODESCHINI, MOISSY-CRAMAYEL (FR)

(21) Appl. No.: 19/115,329

(22) PCT Filed: Sep. 5, 2023
(86) PCT No.: PCT/EP2023/074337

§ 371 Date: Mar. 26, 2025

(30) Foreign Application Priority Data
Sep. 27, 2022 (FR) FR2209808

(51) Int. Cl. G08G 5/26; G01S 13/46; G05D 1/247; G05D 1/654; G05D 109/25; G08G 5/54; H01Q 1/28; H01Q 9/16; H01Q 21/00; H04J 3/06; H04W 56/00

(52) U.S. Cl. CPC G08G 5/26; G01S 13/46; G05D 1/247; G05D 1/6545; G08G 5/54; H01Q 1/28; H01Q 9/16; H01Q 21/00; H04J 3/0667; H04W 56/001; G01S 2013/466; G05D 2109/25

(57) ABSTRACT

A method for assisting in landing of an aircraft includes synchronizing an on-board system and a ground system by exchanging an item of timestamp item of information between the ground system and the on-board system, estimating an item of information characteristic of the distance separating the aircraft from a sub-module of the ground system, and combining the information to infer therefrom an item of information characteristic of the raw general direction of arrival of the aircraft, estimating an item of information characteristic of the direction of a signal transmitted by the aircraft with respect to the ground system, comparing the item of information characteristic of the raw general direction of arrival of the aircraft with the item of information characteristic of the direction, and determining an item of information characteristic of the refined general direction of arrival of the aircraft with respect to the given point in the landing zone.

The present invention relates to the field of assistance in the landing of an aircraft.

### PRIOR ART OF THE INVENTION

To assist aircraft in landing on a specific zone, in particular vertical take-off and landing aircraft, a differential GPS system is commonly used.

Such a system comprises a network of satellites as well as a network of fixed reference stations, with the system transmitting to its main receiver the difference between assumed positions of the fixed stations indicated by the satellites and the actual known positions of these same stations.

To this end, it is common to rely on “Time Of Arrival” (TOA) measurements of signals exchanged within the system, directly related to the distance between the various elements of the system, and to compare these signals via processes known as “Time Difference Of Arrival” (TDOA) processes.

Another alternative is to rely on “Direction of Arrival” or (DOA) measurements of the signals exchanged within the system, directly related to the angularity between the various elements of the system, through processes called “DOA processes”.

In any case, the estimates based on TDOA processes or DOA processes have biases that may be significant in the event the exchanged signals are jammed, or where there is accidental or intentional jamming which affects the quality of the landing assistance provided to the aircraft.

### OBJECT OF THE INVENTION

The aim of the invention is to provide a method for assisting in the landing of an aircraft that is more efficient than existing methods.

### SUMMARY OF THE INVENTION

To this end, the invention provides a method for assisting in the landing of an aircraft that includes an on-board system, on a landing zone associated with a ground system, said ground system comprising several sub-modules of communication each comprising an antenna, the on-board system and the ground system being capable of communicating together.

According to the invention, the method comprises the steps of:
during a first landing phase, synchronising the on-board system and the ground system by exchanging at least one item of timestamp information between the ground system and the on-board system,
during a second landing phase, after the first landing phase:
   first point: estimating for each sub-module at least one item of information characteristic of the distance separating the aircraft from the relevant sub-module, and combining the information in order to infer therefrom at least one item of information characteristic of the raw general direction of arrival of the aircraft relative to a given point of the landing zone,
   second point: estimating at least one item of information characteristic of the direction of a signal transmitted by the aircraft with respect to the ground system,
   third point: comparing the item of information characteristic of the raw general direction of arrival of the aircraft established at the first point with at least the item of information characteristic of the direction of the second point, and determining at least one item of information characteristic of the refined general direction of arrival of the aircraft with respect to the given point in the landing zone,
   fourth point: guiding the aircraft on the basis of said item of information characteristic of the refined general direction of arrival of the aircraft with respect to the given point of the landing zone.

Therefore, the location of the aircraft is based on the joint use of the detection of at least one distance and at least one angle of arrival of the aircraft with respect to the given point of the landing zone, with a time synchronisation between the on-board system and the ground system. The inventors have been able to observe that this serves to obtain a very good location of the aircraft. This simplifies the aircraft's landing assistance.

Indeed, the invention provides good location of the aircraft with respect to the landing zone in time and space (in three dimensions). Thus the inventors have been able to observe that it is possible to have sub-metric accuracy with respect to the position of the aircraft in space.

The inventors have also found that it is possible to obtain an accurate time synchronisation between the on-board system and the ground system at less than 10 nanoseconds.

The invention is particularly advantageous for landings in urban areas where there are many jamming and multipath signals.

Optionally, the timestamp item of information is that of a reference clock.

Optionally, the reference clock is an atomic clock.

Optionally, the atomic clock is coupled to at least one receiver of a satellite positioning system.

Optionally, the synchronisation step is performed by means of a “Precision Time Protocol”.

Optionally, the on-board system and the ground system are configured to exchange data via a radio link that is compatible with an internet protocol.

Optionally, the internet protocol is a “user datagram protocol”.

Optionally, the link is a C2 link.

Optionally, the given point of the landing zone is the centre of the landing zone.

Optionally, the item of information characteristic of the distance between the aircraft and each of the sub-modules is a pseudo-distance.

Optionally, the pseudo-distance is determined by a “time difference of arrival” process.

Optionally, at the first point, the information is combined through multilateration.

Optionally, at the second point, the item of information characteristic of the direction of a signal transmitted by the aircraft is a “direction of arrival”.

Optionally, at the third point, the raw general direction of arrival of the aircraft is used to differentiate a direction of a signal transmitted by the aircraft from directions of signals transmitted by or from jammers.

Optionally, the jammers are rejected by an anti-jamming system.

Optionally, the anti-jamming system is an anti-jamming system with a controlled radiation datagram antenna.

Optionally, the method comprises at least one step consisting in filtering the item of information characteristic of the direction of a signal transmitted by the aircraft with respect to the ground system and/or a step consisting in filtering the refined general direction of arrival of the aircraft with respect to the given point in the landing zone.

Optionally, the ground system has four antennas.

Optionally, the distance separating two antennas of the ground system is greater than half the radiation wavelength of one of the two said antennas.

Other features and advantages of the invention will become clear on reading the following description of a particular and non-limiting embodiment of the invention.

### BRIEF DESCRIPTION OF THE DRAWINGS

Reference will be made to the accompanying drawings, among them:

FIG. 1 schematically illustrates a part of the installation according to a particular implementation of the invention.

FIG. 2 schematically illustrates an on-board system of the installation illustrated in FIG. 1.

FIG. 3 schematically illustrates a ground system of the installation illustrated in FIG. 1.

FIG. 4 schematically illustrates the various landing phases of an aircraft on a landing zone of the installation illustrated in FIG. 1.

FIG. 5 is a diagram depicting the various steps that can be implemented in the installation illustrated in FIG. 1.

FIG. 6 schematically illustrates an algorithm set up in a ground system of the installation illustrated in FIG. 1.

FIG. 7 schematically illustrates a chronogram of a signal that can be exchanged between the on-board system and the ground system of the installation illustrated in FIG. 1.

### DETAILED DESCRIPTION OF THE INVENTION

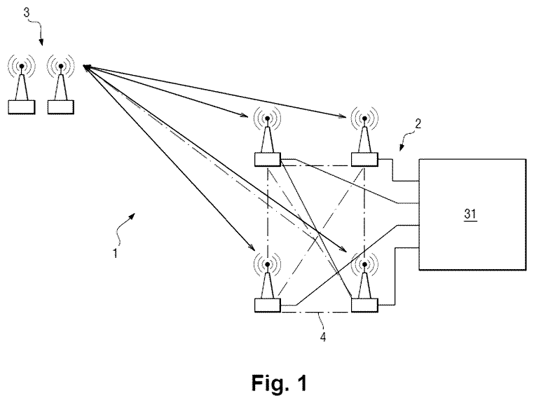

FIG. 1 shows an installation 1 comprising a ground system 2 and an on-board system 3 that is integrated into an aircraft. The installation 1 is thus configured to assist an aircraft during its landing on a given landing zone 4 associated with the on-board system 3. For example, part of the ground system 2 is on the landing zone 4 and another part is in the immediate vicinity of the landing zone 4.

The aircraft can be manned or unmanned. By way of example, the aircraft is a vertical take-off and landing (VTOL) aircraft or, alternatively, an aircraft that is not a VTOL aircraft. Landing may be automatic or not.

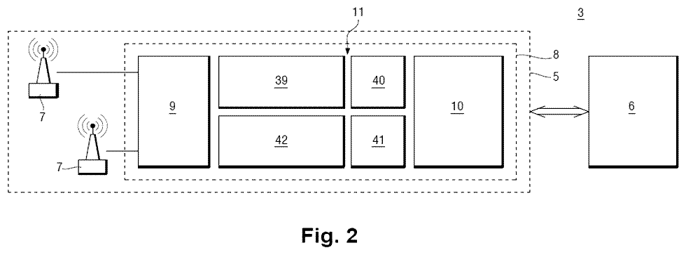

With reference to FIG. 2, the on-board system 3 will be described below.

The on-board system 3 comprises an on-board communication module 5 interconnected with an on-board calculation member 6, such as for example a computer, the on-board calculation member 6 forming or not forming part of the on-board system 3. For example, the computer acts as an autopilot. The on-board communication module 5 and the on-board calculation member 6 are connected to each other, for example via an Ethernet network.

The on-board communication module 5 also comprises at least one antenna 7 associated with at least one on-board link transceiver 8. The antenna 7 is, for example, a dipole antenna.

In the present example, the on-board communication module 5 has two antennas both associated with the on-board link transceiver 8. By way of example, the antennas 7 are dipole antennas.

Said transceiver 8 thus comprises at least one interface 9 for communication with the antennas 7, said communication interface 9 comprising a radio-frequency front end circuit (better known as a “Front End RF”). The aircraft is thus equipped with an on-board communication module 5 whereby it can transmit and receive, by radio transmission by means of its antennas 7, signals with the ground system 2.

In this example, the transceiver 8 also includes at least one interface 10 for communicating with the on-board calculation member 6. In this example, the communication interface 10 is a modulator/demodulator or Modem. It is therefore, in this case, the Modem which is in Ethernet interconnection with the on-board calculation member 6.

The transceiver 8 also comprises a converter apparatus 11 for converting the data exchanged between the on-board system 3 and the ground system 2 (by radio link) into data that can be used for the on-board calculation member 6 (in Ethernet link with the on-board communication module 5). Said converter apparatus 11 will be described below.

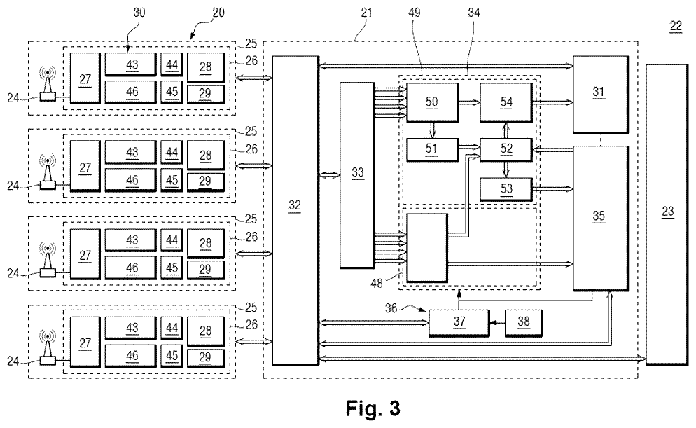

With reference to FIG. 3, the ground system 2 will be described below.

The ground system 2 comprises a ground communication module 20 as well as a landing assistance module 21. The landing assistance module 21 is in communication with a central ground station 22, including at least one central computer 23, forming or not forming part of the ground system. The landing assistance module 21 and the ground station 22 are connected to each other, for example via an Ethernet network and preferably also via a Gigabit Ethernet network. The landing assistance module 21 and the ground communication module 20 are connected to each other for example via an Ethernet network and preferably also via a Gigabit Ethernet network.

The ground station 22 controls and commands the aircraft in its various flight phases. The ground station 22 makes it possible, for example, for an operator to set and/or configure the installation 1 and/or to work in manual mode on the installation 1 whatever the flight phase of the aircraft. Alternatively or additionally, the ground station 22 makes it possible to manage various parameters such as the weather and/or air traffic and/or the air traffic management system for unmanned systems (better known as “Unmanned Aircraft System Traffic Management”).

Alternatively or additionally, during the landing phases, the ground station 22 makes it possible to control the landing assistance module 21 and in particular the paths to be followed and/or the flight corridors to be taken for the landing of the aircraft and/or the flight plans of the aircraft, to be followed by the aircraft during the landing phases and determined by the landing assistance module 21.

The ground communication module 20 comprises a plurality of antennas 24. At least one of the antennas 24 is, for example, a dipole antenna.

The antennas 24 are in this case arranged on the landing zone 4 so as to delineate it.

For example, the ground communication module 20 comprises four antennas 24 arranged in a square such as, for example, and in a non-limiting manner, in a square of 50 meters in dimension. The square thus defines the landing zone 4 of the aircraft, with it being understood that it will be preferable to land the aircraft as close as possible to the centre of this square.

The use of four antennas 24 advantageously makes it possible to have an antenna system of the MIMO (Multiple-Input Multiple-Output) type.

Preferably, the four antennas 24 are arranged to form an macroscopic array of antennas. This means that the distance between the first antenna and the second antenna is significantly greater than half the wavelength associated with the resonant frequency of the first antenna.

This makes it possible to limit a risk of coupling between the various antennas 24.

The ground communication module 20 in this case comprises a communication sub-module 25 each associated with one of the antennas 24 of the ground communication module, the sub-module 25 including the antenna 24 in question, which can also be called a “radio anchor”. Each radio anchor thus has a known position (by the ground system 2) in a Cartesian coordinate system related to the landing zone 4 since each radio anchor is fixed with respect to said landing zone 4.

The sub-modules 25 are preferably all identical to one another so that the following description of one of the sub-modules 25 also applies to the other three sub-modules 25.

The sub-module 25 thus comprises a ground link transceiver 26 that is associated with the ground antenna 24 in question.

Said transceiver 26 thus comprises at least one communication interface 27 associated with the ground antenna 24 in question, said interface 27 comprising a front end radio-frequency circuit. The ground system 2 is thus equipped with a communication module 20 whereby it can transmit and receive, by radio transmission via its antennas 24, signals with the on-board system 3.

Said transceiver comprises an interface 28 for communication with the landing assistance module 21. Said interface 28 comprises, for example, an Ethernet I/O device and preferably also a Gigabit Ethernet I/O device.

The transceiver 26 also comprises a converter apparatus 30 for converting the data exchanged between the on-board system 3 and the ground system 2 (by radio link) into data that can be used for the landing assistance module 21 (in Ethernet link with the ground communication module 20). Said converter apparatus 30 will be described below.

Furthermore, the transceiver 26 comprises means 29 (such as a memory) for storing at least one computer program that supports at least one algorithm which will be detailed below.

The structure of the landing assistance module 21 will now be described.

The landing assistance module 21 comprises at least one item of equipment corresponding with the ground station 22, on the one hand, and the ground communication module 20, on the other hand, (through which the landing assistance module 21 can communicate with the on-board system 3). It is therefore the correspondence item of equipment that is in Ethernet interconnection (in this case Gigabit Ethernet) with the ground station 22 and the ground communication module 20. Furthermore, unless otherwise stated, the various elements of the landing assistance module 21 are interconnected by Ethernet and preferably by Giga-Ethernet.

The correspondence item of equipment comprises a specific communication interface 31 which in this case is a modulator/demodulator or Modem. The communication interface is called specific in that it is mainly intended for communication with the on-board system 3.

The correspondence item of equipment also comprises a general communication interface which is for example a switch 32. By way of example, the switch 32 may be an Ethernet switch, for example a Switch Gigabit Ethernet.

The communication interface is called general in that it provides an interconnection (in this case by Gigabit Ethernet) between the on-board communication module 5 and the landing assistance module 21 as well as between the landing assistance module 21 and the ground station 22 but also between elements of the landing assistance module 21 as well as between elements of the ground communication module 20.

Thus, the switch 32 in this case serves to distribute the data streams between:
the landing assistance module 21 and the ground station 22, and/or
the landing assistance module 21 and the various sub-modules 25, and/or
the various sub-modules 25 relative to one another, and/or
one or more elements of the landing assistance module 21 and one or more other elements of the landing assistance module 21.

Preferably, the landing assistance module 21 comprises at least one Ethernet I/O device 33 (or Gigabit Ethernet I/O device) interconnected to the switch 32.

Said landing assistance module 21 also comprises at least one calculation member 34, such as, for example, a computer. The calculation member 34 is interconnected to said Ethernet I/O device 33 such that it communicates via said Ethernet I/O device 33 with the switch 32 and thereby with the outside of the landing assistance module 21. The calculation member 34 in this case comprises means for storing (such as a memory) at least one computer program supporting at least one algorithm which will be detailed below.

In addition, the landing assistance module 21 comprises a member 35 for managing the movement of the aircraft with respect to the landing zone 4. Said management member 35 is interconnected to the switch 32 as well as, in this case, to the specific communication interface 31.

The landing assistance module 21 comprises a synchronisation device 36 that is interconnected to the switch.

By way of example, the synchronisation device 36 comprises a time server 37.

The time server 37 is a “Network Time Protocol” (NTP) time server 37, and preferably a “Precision Time Protocol” (PTP) time server 37, i.e. a PTP time server 37. It should be noted that the PTP is an Ethernet clock synchronisation protocol, standardised under the name IEEE 1588V1 for the first version, IEEE 1588V2 for the second version or else IEC 61588.

The synchronisation device 36 is configured to synchronise the various elements of the landing assistance module 21 and preferably to synchronise the various elements of the ground system 2 with each other and more preferably to synchronise the various elements of the ground system 2 and the on-board system 3 with each other. For the remainder of the application, the term “synchronisation” is used to mean PTP synchronisation (which may also be referred to as IEEE 1588 V2 protocol synchronisation).

Therefore, the specific communication interface 31 is, in this case, able to implement the PTP protocol; the communication interface 10 is able to implement the PTP protocol; the switch 32 is a switch that is able to implement the PTP protocol; the communication interface 28 of each sub-module 25 is an interface that is able to implement the PTP protocol; the I/O device 33 is an I/O device that is able to implement the PTP protocol; the management member 35 is a device that is able to implement the PTP protocol; etc.

Since the time server 37 must transmit a timestamp to the various elements of the installation, it is therefore indexed to a reference clock 38.

Preferably, said reference clock 38 is an atomic clock.

Preferably also, said atomic clock 38 is coupled to at least one receiver of a satellite positioning system, or GNSS system (GPS, GALILEO, GLONASS, etc.). This makes it possible to couple installation 1 with said GNSS system. However, it should be noted that if this GNSS system is not available, even temporarily, the installation 1 can continue to operate without performance losses given that the reference clock 38 is an atomic clock.

Said reference clock 38 may or may not be part of the ground system 3 and/or may or may not be part of the landing assistance module 21. In the present example, the reference clock is incorporated into the landing assistance module 21 and more particularly into the synchronisation device 36.

Within the landing assistance module 21, an item of information characteristic of the reference clock 38 (such as timestamp item of information indexed to the reference clock 38) is, for example, transmitted by the time server 37 at least to the calculation member 34 and to the specific communication interface 31 (either directly or via the calculation member 34).

Preferably, the management member 35 and/or the switch 2 also receives said item of information characteristic of the reference clock 38.

Within the installation 1, the item of information characteristic of the reference clock 38 is then transmitted at least to the various sub-modules 35 (via the switch 32) and preferably also to the on-board communication module 5 (via the specific communication interface 31, the switch 32 and then the ground communication module 20). Preferably, the item of information characteristic of the reference clock 38 is also transmitted to the ground station 22 (via the switch 32).

It can thus be understood that the entire ground system 2 is therefore synchronised with the reference clock 38, and that the on-board system 3 is also synchronized with said reference clock 38. The installation 1 thus described serves to exchange timestamp item of information between the on-board system 3 and the ground system 2 in order to synchronise the installation 1. It should be noted that this synchronisation is carried out on the basis of precise timestamp item of information, i.e. over a specific period of time. In the present example, synchronisation with precise timestamp item of information, in particular between the on-board system 3 and the ground system 2, is carried out in particular by the time server 37 and the use of the PTP protocol (sometimes called the IEEE1588V2 protocol) through the connections between the on-board system 3 and the ground system 2.

In another aspect, in the installation 1 thus described, the intra-ground system connections 2 are based on a conventional Internet Protocol (IP)—which therefore makes it possible to apply the PTP protocol—and, by way of example, an IP protocol of the “User Datagram Protocol” (UDP) type. The intra-on-board system 3 connections are also based, in this case, on a UDP/IP protocol—which therefore makes it possible to apply the PTP protocol.

The ground system 2 and the on-board system 3 are configured to be able to communicate with each other by means of a radio link which is preferably also compatible with an IP protocol—which therefore serves to apply the PTP protocol—and for example with a UDP/IP protocol.

As a result, the entire installation 1 uses the same protocol (in this case UDP/IP) for data exchange, which simplifies communication within the installation 1.

For example, the installation 1 is configured so that the ground system 2/on-board system 3 link is a “command and control” link, also called a C2 link, that supports IP protocols and for example the UDP/IP protocol.

This is particularly advantageous in the context of a military application. Specifically, the C2 link complies with a NATO tactical data link standard.

Below, therefore, reference will be made to a C2 link between the specific communication interface 31 and the communication interface 9 of the on-board system 3. The C2 link is thus a two-way link.

The C2 link is a radio link. The C2 link furthermore supports the UDP/IP protocol. The C2 link thus makes it possible to exchange the item of information characteristic of the reference clock 38 between the on-board system 3 and the ground system 2.

Any C2 link signal has a particular waveform shown in FIG. 7. The signal, in this case, successively presents a “burst guard time” 100, a “HPA ramping” 101, a preamble 102, a mode 103, a timestamp field 104, a data sequence 105 and again a “HPA ramping” 106.

The timestamp item of information can thus be exchanged between the on-board system 3 and the ground system 2 through the timestamp field.

Consequently, the specific communication interface 31 is a C2 specific communication interface (in this case a C2 Modem), i.e. an interface making it possible to transmit (via the switch 32 and then the communication module 20 of the ground system 2) to the aircraft (and more precisely with the communication interface 10) data streams that comply with the C2 link standard. In this case, the communication interface 10 is an C2 on-board communication interface (in this case a C2 Modem), i.e. a communication interface that serves to transmit (via the communication module 20 and then the switch 32) to the ground system 2 (and more precisely to the specific communication interface 31) data streams complying with the C2 link standard.

It should be noted here that the specific communication interface 31 and the communication interface 10 do not communicate directly with each other but in particular via the on-board 5 and ground 20 communication modules and in particular the on-board 7 and ground 24 antennas.

Furthermore, it will be reminded that the C2 link is a radio link while the elements of the on-board system 3 communicate with each other largely via Ethernet and the elements of the ground system 2 communicate with each other largely via Ethernet.

Therefore, the purpose of the converter apparatus 11 of the on-board system 3 is to adapt data received from the ground system 2, via the C2 link, into data that can be used by the rest of the on-board system 3 and vice versa.

For example, the converter apparatus 11 comprises a unit 39 for transposing the frequencies of the received signals (frequencies belonging to a radio frequency band allocated to the C2 link) to a basic radio frequency band (the basic radio frequency band being substantially 0 Hertz while the radio frequency band allocated to the C2 link being of the order of some GigaHertz) and then filtering the signals obtained, said unit 39 being arranged downstream of the Front End RF c circuit 9. Optionally, the converter apparatus 11 also comprises a unit for controlling the gain of the signals received and, for example, an automatic gain control (AGC) unit. Such a unit makes it possible to amplify the signals received and thereby compensate for transmission losses particularly those caused by the distance between the aircraft and the ground system 2. Such a unit can be arranged inside the unit 39, downstream from the unit 39 or upstream from the unit 39.

The converter apparatus 11 also comprises a unit 40 (such as an ADC) for sampling the filtered signals supplied by the unit 39 (optionally the gain control unit) into digital data which can thus be exchanged by Ethernet link within the aircraft.

Conversely, the converter apparatus 11 comprises a unit 41 for sampling (such as a DAC) digital data to be transmitted to the ground system 2 followed by a unit 42 for filtering and transposing the data supplied by the unit 41 onto the radio frequency band of the C2 link.

Similarly, the purpose of the converter apparatus 30 (only one of which is referenced in this case) of each transceiver 26 of the ground system 2 is to adapt data received from the on-board system 3, via the C2 link, into data that can be used by the remainder of the ground system 2 and vice versa.

For example, the converter apparatus 30 comprises a unit 43 for transposing the frequencies of the received signals (frequencies belonging to a radio frequency band allocated to the C2 link) to the basic radio frequency band and then filtering the signals obtained, said unit 43 being arranged downstream of the Front End RF circuit. The converter apparatus 30 optionally comprises a unit for controlling the gain of the signals received and, for example, an automatic gain control unit. Such a unit can be arranged inside the unit 43, downstream from the unit 43 or upstream from the unit 43.

The converter apparatus 30 also comprises a unit 44 (such as an ADC) for sampling the filtered signals supplied by the unit 43 (optionally of the signal gain control unit) into digital data which can thus be exchanged by Ethernet link within the remainder of the ground system 2.

Conversely, the converter apparatus 30 comprises a unit 45 (such as a ADC) for sampling digital data to be transmitted to the on-board system 3, followed by a unit 46 for filtering and transposing the data supplied by the unit 45 onto the radio frequency band of the C2 link.

The calculation member 34 and the transceivers 29 supporting algorithms and which have already been introduced, will now be described.

Each transceiver 29 comprises a unit 47 for estimating at least one item of information characteristic of a distance separating the aircraft from each the sub-modules 25 (and therefore from the antennas 24). By way of example, the characteristic item of information is an item of information characteristic of a pseudo-distance separating the aircraft from each of the sub-modules 25. By way of example, the characteristic information may be a TOA or a TDOA.

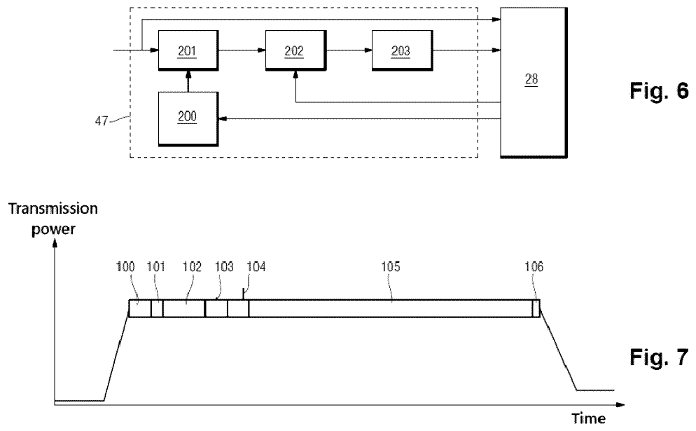

With reference to FIG. 6, an example of the implementation of bloc 47 will now be described.

The on-board system 3 generates a reference signal via the C2 link which is picked up by the transceiver 26.

The unit 47 determines, during the first phase 201, a convolution between the preamble 200 of the reference signal and a pattern of this preamble (which is known and predefined) in order to obtain a correlation peak.

The unit 47 determines during the second phase 202 from the reference signal, a TDOA between the aircraft and the sub-module in question. For example, the unit 47 determines several TOAs between the aircraft and the antenna 24 of the sub-module 25 from the time that the reference signal took to reach the antenna 24 in question (directly related to the distance between the aircraft and said antenna since the position of the latter is fixed and therefore known in a Cartesian coordinate system related to the landing zone 4). To obtain several TOAs, the unit 47 performs the same measurement several times (for example at regular time intervals of short duration). The unit 47 compares said TOAs to obtain the TDOA which is representative of the average of the various TOAS.

Advantageously, during this second phase 202, the unit uses the correlation peak as a time synchronisation “start cue” to perform the TOA measurements and/or obtain the TDOA.

In fact, the time synchronisation “start cue” makes it possible to carry out a first time framing between the on-board system 3 and the ground system 2, i.e. coarse synchronisation between the two systems. The synchronisation between the on-board system 3 and the ground system 2 is then reinforced by the sharing of precise time (the timestamp item of information) within the installation and in particular by the transmission of the timestamp information via the C2 link.

Therefore, the correlation peak is advantageously added to the synchronisation by sharing the timestamp item of information.

Preferably, the unit 47 comprises a third phase 203 for filtering the TDOA obtained. For this purpose, the unit 47 incorporates a filter such as, for example, a Kalman filter. In particular, this serves to improve the accuracy of the measurement of the time of flight of the reference signal representative of the aircraft/sub-module distance 25 in question. The Kalman filter can be based on the various TOAs calculated in the previous phase 202 to obtain the filtered TDOA.

Therefore, the unit 47 transmits a filtered TDOA to the landing assistance module 21, and in particular to the calculation member 34, and in particular to a unit 48 (of said calculation member 34) for determining at least one item of information characteristic of the raw general direction of arrival of the aircraft relative to a given point of the landing zone 4. By way of example, the given point is the centre of the landing zone 4.

For example, said unit 48 receives all the filtered TDOAs and combines these various signals in order to obtain:
the raw general direction of arrival of the aircraft in the Cartesian coordinate system linked to the landing zone 4 and/or
the distance between the aircraft and the landing zone 4 and more specifically the distance between a given point of the aircraft (for example its centre of gravity) and the given point of the landing zone 4.

Thus, the calculation member 34 is here configured to determine two items of information characteristic of the raw general direction of arrival of the aircraft relative to a given point of the landing zone 4.

By way of example, the unit 48 combines the various signals by multilateration.

Furthermore, it should be noted that the raw general direction is expressed by three coordinates (x, y, z) in the aforementioned Cartesian coordinate system.

Preferably, the unit 48 is thus configured to transform these coordinates into spherical coordinates. The spherical coordinates thus obtained provide in particular the raw elevation angle and the raw azimuth angle of the aircraft and therefore a raw DOA of the aircraft.

The unit 48, in this case, transmits the aircraft/landing zone distance to the management member 35.

The unit 48 also transmits, in this case, the raw DOA to a unit 49 (belonging to the calculation member) for determining the item of information characteristic of the refined general direction of arrival of the aircraft relative to the given point in the landing zone 4.

It should thus be observed that the ground system 2 supports a general algorithm distributed between the communication module 20 (by determining the TDOA) and the landing assistance module 21 (by multilateration) making it possible to determine the DOA of the aircraft and its distance relative to the landing zone 4.

The unit 49 for determining the item of information characteristic of the refined general direction of arrival of the aircraft relative to the given point in the landing zone 4 will be described below.

Preferably, the unit 49 comprises a sub-unit 50 for readjusting the various communication channels coming from the various sub-modules 25.

This serves to take into consideration the fact that the connection distances between the various sub-modules 25 and the landing assistance module 21 are not identical. The sub-unit 50 therefore compensates for errors in calibrations and delays between the various sub-modules 25. All the signals coming from the various sub-modules 25 are thus synchronised.

The unit 49 also comprises a sub-unit 51 which, on the basis of the readjusted signals supplied by the sub-unit 50, will detect DOAs including those of the signal transmitted by the aircraft but also those possibly transmitted by jammers (expressed in spherical coordinates in the coordinate system linked to the landing zone).

This information is transmitted to another sub-unit 52 of the unit which also receives the previously calculated raw DOA from unit 48. The sub-unit 52 combines these various items of information to differentiate the DOAs of the jammers from those of the aircraft.

Furthermore, the sub-unit 52 then refines the previously calculated raw DOA with the DOA thus obtained by the succession of sub-units 50-51 to obtain a refined DOA.

In addition, the sub-unit 52 communicates with an additional sub-unit 54 of the unit 49 to provide it with information characteristic 44 DOAs and the aircraft DOAs thus obtained by the succession of sub-units 50-51-52. Said sub-unit 54 infers therefrom a rejection of the signals from the jammers in order to retain only the signal specific to the aircraft.

The signal specific to the aircraft (in this case a C2 type signal) is thus transmitted to the specific communication interface 31. Therefore, the specific communication interface 31 can thus transmit this signal to the aircraft and/or to the ground station 22, the latter supervising the landing of the aircraft.

The unit 49 thus described relies in this case (and in particular its sub-unit 54) on a Controlled Radiation Pattern Antenna) (CRPA) process to reject the jammers (in their direction of arrival) and also to determine the direction of arrival of the jammers. The rejection capacity of this method makes it possible to reject up to two jammers simultaneously (among three signals including that from the aircraft).

In an ingenious manner not known in the prior art, it is the raw DOA transmitted by the unit 48 that makes it possible to distinguish from among the signals identified by the sub-unit 51 between the signal coming from the aircraft and those coming from the jammers.

The combination of the CRPA process with the raw DOA transmitted by unit 48 is therefore particularly ingenious and not known in the prior art.

Furthermore, it is understood that two different DOAs of the aircraft are estimated in this case: one by the succession of the sub-units 50-51-52 and the other by unit 48. It should be noted that the DOA obtained by the succession of sub-units 50-51-52 is more precise than that obtained by unit 48, in particular for the most closed angles i.e. those closest to zero. By combining said two DOAs, a refined DOA with very good accuracy is obtained.

Preferably, the unit 49 also comprises a filtering sub-unit 53. For this purpose, the sub-unit 53 comprises a filter, and for example, a Kalman filter. The refined DOA is thus transmitted by the sub-unit 52 to the sub-unit 53.

This serves even more to improve the determination of the DOA of the aircraft, for example by reducing the noise on the angular measurements.

The inventors have thus been able to obtain an accuracy on the azimuth and elevation angles output from the Kalman filter of the order of 0.1°.

The filtered refined DOA is then sent to the management member 35.

It is therefore understood that the unit 49 is configured to carry out a spatial filtering of the various signals received by the ground system 2 in order, in particular, to differentiate the aircraft from any jammers and thereby to be able to provide a filtered refined DOA to the management member.

Preferably, the unit 49 is also configured to additionally carry out time filtering of the various signals received by the ground system 2 in order, in particular, to be able to eliminate the “echo” signals, i.e. the signals originating from the reflection of the radio waves on obstacles such as buildings. The filtering can be done on a time basis since the “echoes” will take longer to reach the ground system 2 than the initial signal due to the reflections.

The time filtering of the unit 49 is therefore called “multi-path” filtering.

Such filtering may, for example, be implemented in one of the sub-units of the unit 49. For example, the CRPA process implemented in unit 49 can directly integrate this multi-path filtering and also assist in rejecting jammers.

The French patent application FR 3 116 401 of the present applicant therefore proposes a CRPA process that may include such multi-path filtering.

The management member 35 thus receives from the unit 49 the filtered refined DOA as well as the aircraft/landing zone distance as previously stated and optionally the DOA of the jammers.

On the basis of this data and a predefined path, the management member 35 determines a corrected landing path of the aircraft.

Preferably, the management member 35 also determines said path from the signal specific to the aircraft transmitted to the specific communication interface 31 which itself transmits it to the management member 35.

This corrected landing path of the aircraft is transmitted first to the specific communication interface 31, then to the switch 32, then to the ground communication module 20, then to the on-board communication module 5, then to the communication interface 10 and lastly to the calculation member 6 (and optionally to its autopilot).

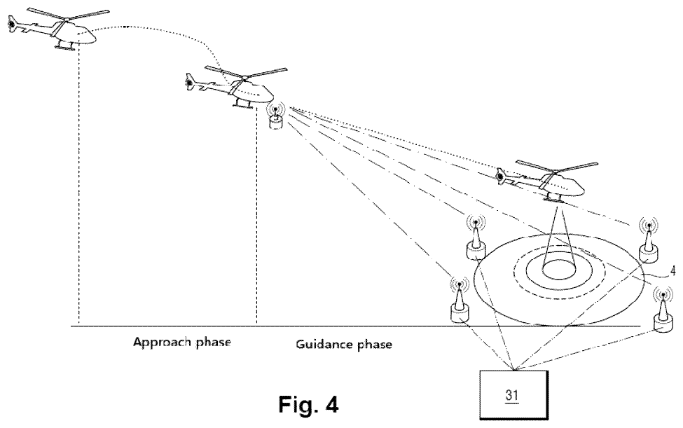

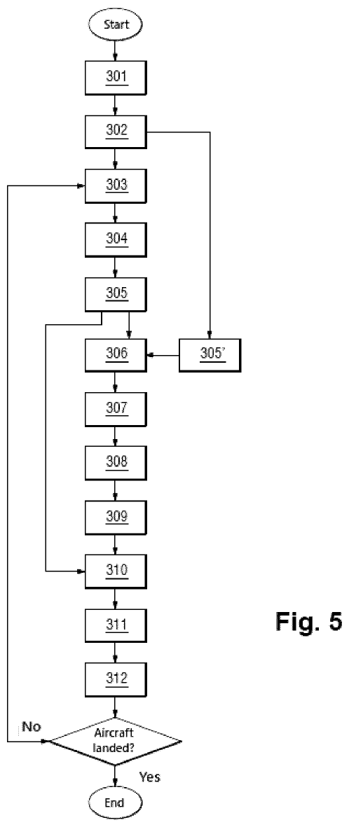

With reference to FIGS. 4 and 5, there follows a description of a particular implementation of the method implemented in the installation described above.

During an approach phase, the aircraft approaches the landing zone 4.

When the aircraft is close enough to the landing zone for the on-board 3 and ground 2 systems to communicate with each other, the guidance phase begins. For example, the guidance phase begins when the aircraft is at a distance from the given point in the landing zone 4 of between 7,000 and 5,000 metres and for example at a distance of approximately 6,000 metres from the given point in the landing zone. The aircraft is then at an altitude of about 500 metres from the ground.

During a first step 301, communication is established between the ground system 2 and the on-board system 3 and more particularly between the specific communication interface 31 and the communication interface 10 (through other elements as already stated). This communication occurs via the C2 link as already stated.

In a second step 302, the ground system 2 and the on-board system synchronised with each other by exchanging the timestamp item of information related to the reference clock and optionally using the correlation peak. The timestamp item of information is exchanged using the PTP protocol via the C2 link, said C2 link also advantageously making it possible to obtain the correlation peak. The correlation peak makes it possible to carry out a first time framing which is refined through the sharing of the timestamp information.

This step 302 also includes synchronisation of the various elements of the ground system 2 with each other (with the difference that the timestamp information is then exchanged by Ethernet connection and not through the C2 link). This step also includes synchronising the various elements of the on-board system 3 with each other (except that the timestamp information is then exchanged within the on-board system by Ethernet connection and not through the C2 link).

At the end of the second step 302, preferably, the entire installation 1 is synchronised to the reference clock.

The fact of synchronising at least the ground system 2 and the on-board system 3 with each other makes it possible to improve the accuracy of the measurements carried out to geolocate the aircraft.

This limits in particular the bias on the measurements and therefore on the determination of the position of the aircraft.

During a third step 303, the TDOA is calculated at each sub-module 25 as stated above.

During a fourth step 304, filtering is applied to each TDOA, such as, for example, Kalman filtering, to finally obtain four filtered TDOAs.

During a fifth step 305, these various filtered TDOAs are combined together, for example by multilateration, to obtain an aircraft-landing zone distance as well as a raw DOA of the aircraft.

During a fifth step bis 305′, a resetting is performed between the various transmitter/receiver communication channels 26 of the ground system 2. For this purpose, the delay between said various channels during the second synchronisation step 302 is relied on, for example.

During a sixth step 306, the DOA of the signals arriving on the various abovementioned communication channels is determined. Preferably, the pseudo-spectrum making up the combined diagram of the various antennas 24 of the ground communication module 20 is used for this purpose.

In a seventh step 307, using the raw DOA of the aircraft obtained in the fifth step 305, a distinction is made between the various DOAs obtained in the sixth step 306, that of the aircraft and those of any jammers.

It should thus be noted here that it is the raw DOA of the aircraft (obtained via TDOA) that makes it possible to distinguish between the signal coming from the aircraft and that of any jammers.

During this step 307, the refined DOA of the aircraft is also determined.

In an eighth step 308, the signals coming from the jammers are rejected to thereby retain only the signal coming from the aircraft.

During a ninth step 309, the signal from the aircraft is translated into a signal that can be used by the management member 35 (for example, the signal is demodulated).

During a tenth step 310, using the signal translated in the ninth step 309, from the refined (optionally filtered) DOA obtained in the seventh step 307 and from the aircraft-landing zone distance obtained in the fifth step 305, a path in four dimensions (time and space-for example aircraft/landing zone distance, azimuth angle and elevation angle) of the aircraft is determined.

During an eleventh step 311, at least one set point for guiding the path is inferred therefrom, in particular facing an approach corridor and a predefined initial path.

During a twelfth step 312, the guidance set point is transmitted to the aircraft in particular via the specific communication interface 31, the switch 32, the ground communication module 20 and the on-board communication module 5.

Steps 3 to 12 are repeated until the aircraft is landed.

The above description relates to an installation and a method for assisting in the landing of an aircraft.

An installation and a method have therefore been described for assisting in the landing of an aircraft, and in particular and in a non-limiting manner, the automatic landing of an aircraft.

Synchronisation by sharing a precise time within the installation makes it possible to greatly improve the landing assistance of the aircraft.

The installation and method thus described are based on radiolocation to assist in the landing of an aircraft.

Advantageously, the combination of determining the DOA of the aircraft (by dual method) and the CRPA anti-jamming process limits the risks of uncertainties related to the jamming (accidental or not) of the signals received by the ground communication module.

On the other hand, the combination of determining the TOA and DOA with the CRPA anti-jamming process makes it possible to reject any jammers (usually up to two jammers) in the directions of their arrival.

This is particularly advantageous in the case of an application in an urban environment where jammings and multipaths can be significant.

The installation and the method described above are based on the joint use of the difference between the times of arrival of a reference signal transmitted periodically by the aircraft and the angle of arrival at the radio anchors on the ground.

Naturally, the invention is not limited to the particular implementations described, but includes any variant coming into the scope of the invention as defined by the claims.

Thus, the aircraft could be any type of apparatus capable of moving in the air such as an airplane, a helicopter, a drone, a reusable launcher, etc.

Although, in this case, the unit is integrated into the ground communication module, said unit could be integrated into the landing assistance module.

Although, in this case, the given point is the centre of the landing zone, the given point could be another point in the landing zone, for example one of the corners of the landing zone.

Although, in this case, the landing zone comprises four sub-modules, the landing zone could comprise a different number of sub-modules, and, for example, comprise at least three sub-modules each equipped with an antenna.

Although, in this case, the landing zone is land-based, the landing zone could be a naval landing zone, such as a helipad on a ship. Preferably, the attitudes of the ship and the aircraft will be exchanged between the on-board system and the ground system.

The installation may include a laser altimeter to allow final guidance when the aircraft is a few metres from the given point in the landing zone. This will facilitate final guidance with an accuracy to within a few centimetres.

The installation may be configured to take into account one or more additional parameters than the refined DOA of the aircraft to assist in the landing, such as, for example, air traffic around the landing zone, the availability of the landing zone, the weather (such as the direction of the wind), etc.

The method may include a phase of characterisation for each antenna of the ground system in order, if necessary, to obtain the pseudo-spectrum making up the combined radiation pattern of the various antennas of the ground system.

Each sub-module may include calibration means for taking into account the gain and/or phase variations specific to each sub-module as a function of the transmission and/or reception frequency of the sub-module in question and the temperature of said sub-module. The ground system, and for example the ground communication module, may thus comprise a unit for harmonising gains and/or phases between the various sub-modules.

The installation will have a commercial rather than a military application.

The installation may not comply with a NATO tactical data link standard, the ground system/on-board system link then being another radio link making it possible to support an IP protocol and preferably a standardised protocol called IEEE 1588V1 for the first version, IEEE 1588V2 for the second version or else IEC 61588.

The various steps of the method could be carried out in a direction different from that stated, it being understood that at least two steps could be carried out at the same time.

The TDOA transmitted by the communication module may not be filtered (or may be filtered within the landing assistance module).

The refined DOA transmitted to the management member may not be filtered or may be filtered within the management member.

If the satellite positioning coordinates (GPS, GNSS, Galileo, etc.) of the aircraft are available and/or unjammed, the management member 35 may recover said coordinates, for example by communication between the aircraft and the management member 35. The management member 35 may use these coordinates (in place of or in addition to one or more of the abovementioned parameters, namely the filtered refined DOA, the aircraft/landing zone distance, the DOA of the jammers and the signal specific to the aircraft) to generate the landing path.

The correlation peak can be dispensed with in order to ensure the synchronisation of the on-board system/ground system.

1. A method for assisting in the landing of an aircraft that includes an on-board system, on a landing zone associated with a ground system, said ground system comprising several communication sub-modules each comprising an antenna, the on-board system and the ground system being able to communicate together, the method being characterised in that it comprises the steps consisting of:
during a first landing phase, synchronising the on-board system and the ground system by exchanging at least one item of timestamp information between the ground system and the on-board system,
during a second landing phase, after the first landing phase:
first point: estimating for each sub-module at least one item of information characteristic of the distance separating the aircraft from the relevant sub-module, and combining the information in order to infer therefrom at least one item of information characteristic of the raw general direction of arrival of the aircraft relative to a given point of the landing zone,
second point: estimating at least one item of information characteristic of the direction of a signal transmitted by the aircraft with respect to the ground system,
third point: comparing the item of information characteristic of the raw general direction of arrival of the aircraft established at the first point with at least the item of information characteristic of the direction of the second point, and determining at least one item of information characteristic of the refined general direction of arrival of the aircraft with respect to the given point in the landing zone,
fourth point: guiding the aircraft on the basis of said item of information characteristic of the refined general direction of arrival of the aircraft with respect to the given point of the landing zone. of information is that of a reference clock.

3. The method according to claim 2, wherein the reference clock is an atomic clock.

4. The method according to claim 3, wherein the atomic clock is coupled to at least one receiver of a satellite positioning system.

5. The method according to claim 1, wherein the synchronising step is implemented by means of a “Precision Time Protocol”.

6. The method according to claim 1, wherein the on-board system and the ground system are configured to exchange data via a radio link that is compatible with an internet protocol.

7. The method according to claim 6, wherein the internet protocol is a “user datagram protocol”.

8. The method according to claim 6, wherein the link is a control and command link.

9. The method according to claim 1, wherein the given point in the landing zone is the centre of the landing zone.

10. The method according to claim 1, wherein the item of information characteristic of the distance separating the aircraft from each of the sub-modules is a pseudo-distance.

11. The method according to claim 10, wherein the pseudo-distance is determined by a “time difference of arrival” process.

12. The method according to claim 1, wherein at the first point, the item of information is combined by multilateration.

13. The method according to claim 1, wherein, at the second point, the item of information characteristic of the direction of a signal transmitted by the aircraft is a “direction of arrival”.

14. The method according to claim 1, wherein at the third point, the raw general direction of arrival of the aircraft is relied on to differentiate the direction of a signal transmitted by the aircraft from directions of signals transmitted by or from jammers.

15. The method according to claim 14, wherein the jammers are rejected by an anti-jamming system.

16. The method according to claim 15, wherein the anti-jamming system is an anti-jamming system with a controlled radiation datagram antenna.

17. The method according to claim 1, including at least a step consisting in filtering the item of information characteristic of the direction of a signal transmitted by the aircraft with respect to the ground system and/or a step consisting in filtering the refined general direction of arrival of the aircraft relative to the given point in the landing zone.

18. The method according to claim 1, wherein the ground system comprises four antennas.

19. The method according to claim 1, wherein the distance separating two antennas of the ground system is greater than half the radiation wavelength of one of said two antennas.
